(19) United States
(12) Patent Application Publication
(10) Pub. No.: US 2007/0128440 A1
(43) Pub. Date: Jun. 7, 2007

(54) Cellular probes

(75) Inventor: David E. Luzzi, Wallingford, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: THE TRUSTEES OF THE UNIVERSITY OF PENNSYLVANIA, PHILADELPHIA, PA (US)

(21) Appl. No.: 10/582,660

(22) PCT Filed: Dec. 10, 2004
(86) PCT No.: PCT/US04/41262

§ 371 Date: Oct. 12, 2006

Related U.S. Application Data
(60) Provisional application No. 60/528,949, filed on Dec. 11, 2003.

(51) Int. Cl. B32B 9/00; G01N 21/00

(52) U.S. Cl. 428/408; 436/164; 422/55

(57) ABSTRACT

Probing tools compnsing nanotubes partially coated with a biocompatible coating capable of absorbing or imbibing bio-reactive materials. Also within are probing systems comprising nanoprobes and microscopes. Methods are also provided comprising partially coating a nanotube with a biocompatible coating, contacting a membrane with the resulting nanoprobe, and, in some embodiments, expelling a molecule.

### FIELD OF THE INVENTION

The invention relates to biofunctional nanoprobes comprising nanotubes coated with biocompatible coatings capable of transporting and delivering bioreactive or other bioactive molecules. Methods of making the nanoprobes and methods of delivery and use are also disclosed.

### BACKGROUND OF THE INVENTION

There is a need for more effective research solutions for programs researching disease or injury processes or chemical interaction processes in which the ability to modify the interior of a cell without damaging the cell membrane is important. The present invention is directed, inter alia, to this important goal.

In the early stages of research, after a specific target has been identified, large volumes of sample are needed for, for instance, testing of the proprietary compounds within a corporate library. Researchers have used this approach in order to screen out those targets that will be unsuccessful. If these target failure can be screened out more efficiently, a great amount of time, money, and expense will be saved. Cellular probe technology is one way of reducing the volumes that has yet to be fully developed.

### SUMMARY OF THE INVENTION

The present invention is directed to probing tools comprising a nanotube at least partially coated with a biocompatible coating capable of absorbing a bioreactive molecule. Preferably, the coating may comprise silica that may be colloidal or spherical. The nanotubes may be multi-walled or double-walled nanotubes. The nanotubes may comprise C₆₀ molecules within its interior.

There are also probing systems comprising a nanotube at least partially coated with a biocompatible coating capable of absorbing a bioreactive molecule, a microscope, and micron-resolved mechanical control. Suitable microscopes comprise light microscopes and atomic force microscopes.

The invention also discloses methods comprising partially coating a nanotube with a biocompatible coating comprising silica to form a bio-functional nanoprobe and contacting a vesicle with said nanoprobe. As used herein, bio-functional means capable of performing an interacting without harmful effect in a biological system. Vesicle, as used herein, refers to any enclosed biological space. Another method that may be preferred further comprises penetrating the vesicle. Other embodiments involve attracting molecules on or within the vesicle to the coating. It will be appreciated that there are methods comprising partially coating a nanotube with a biocompatible coating, absorbing said coating with a bio-reactive molecule, contacting a vesicle with the resulting nanoprobe, and expelling said molecule from said coating. Some method embodiments comprise partially coating a nanotube with colloidal silica, imbibing said silica with a bio-reactive molecule, passing through the vesicle with said coated nanotube, and delivering said molecule. The type of vesicles that may be used comprise lipid membranes such as cells and cell nuclei.

The embodiments of the present invention enable nano-assays as an efficient tool for early screening of drug discovery candidates. It is foreseeable that the invention may be used for in-vitro single-cell laboratory experimentation system for testing of enzyme-cell interactions, fluidic components for manipulation and control of minute quantities of gas or liquid, or development of fluidic devices for high throughput, low-test-volume, drug discovery applications.

### BRIEF DESCRIPTION OF THE DRAWINGS

FIG. 1 displays the absorption monitoring of horseradish peroxidase (HRP) reaction for one embodiment.

FIG. 2 displays the absorption monitoring of HRP reaction, for one embodiment.

FIG. 3 displays the reactivity corrected for MWNTs settling.

FIG. 4 depicts an embodiment of the invention with a tip having Ludox®/HRP coating.

FIG. 5 depicts another embodiment of the invention with a tip having Ludox®/HRP coating.

FIG. 6 depicts another embodiment of the invention with a tip having Ludox®/HRP coating.

FIG. 7 depicts an embodiment of the invention seen under fluorescence microscopy.

### DETAILED DESCRIPTION OF PREFERRED EMBODIMENTS

The probes, systems, and methods of the present invention provide researchers means of examining the interior of cells and other vesicular structures, introduce substances, and remove substances with control and with minimal disruption of the cell or vesicular structure. These embodiments also provide one skilled in the art to provide effect tests of the efficacy of candidate therapeutic agents using human or other cells. Some embodiments may allow one skilled in the art to test the presence of chemical interaction between candidate therapeutic agents or test substances and a particular-disease related target substance within a process of high-throughput screening either within human cells or within reaction vessels of appropriate type.

Embodiments of the present invention provide nanoprobes that introduce small quantities of a substance into a vesicle, such as a cell or cell nucleus and either leave this substance behind or remove the substance after controllable intervals. The substance delivered may be pharmaceutically beneficial, such as a medicament. Other materials, such as markers, reactive moieties, or other substances having biological activity or which may be useful in research or therapeutics may also be employed. This delivery is characterized by minimal disruption of the vesicular structure. Embodiments of the present invention allow for the delivery of specified substances into a cell or a section of a cell without killing the cell or damaging the cell to an experimentally or chemically-significant amount. It also may be preferred to use certain embodiments of the invention as single cell nanoprobes for biomedical research.

To these ends, the present invention provides probing tools comprising a nanotube at least partially coated with a biocompatible coating capable of absorbing bioreactive molecules. As used herein, bio-reactive molecules are those that tend to respond to stimuli found in a biologic system. Embodiments of the invention may also be described as comprising a nanotube having a coating capable of imbibing or absorbing bio-reactive molecules. The coating may comprise molecules considered useful in alleviating an illness or molecules considered useful as a diagnostic. As such, said molecules may also be considered medicaments.

The nanotube component may be described as tubular or solid, high-aspect-ratio fiber with diameter between 1 and 100 nm. The nanotubes suitable for the present invention may be single walled (SWNT), double walled (DWNT), multi-walled (MWNT), or nanotubes modified using techniques known in the art. An example of a modified nanotube is one that comprises Buckminster fullerene, or C₆₀ balls, within its lumen.

In one embodiment, methods have been developed to generate biocompatible coatings at least partially covering nanotubes. The coating may be porous or meso-porous silica. The porous coating may preferably comprise silica or spherical silica particles. The porous nature of the coating lends itself to steric entrapment of bio-reactive molecules. Also envisioned are coatings comprising marking enzymes such as horseradish peroxidase. These molecules may then be introduced into a lipid membrane, cell, or vesicle by using the nanoprobe as an invasive, but non-disruptive probe. It is understood that there may be coatings capable of absorbing molecules found in a lipid membrane or cell and extracting the molecule using the nanoprobe.

A suitable bio-reactive molecule may be horseradish peroxidase (HRP). HRP reduces peroxide, creating a radical oxygen. It then catalyzes the oxidation of 2,2′-Azino-bis(3-ethylbenzotliazoline-6-sulfonic acid) (ABTS) among other molecules. This oxidation of ABTS produces an absorption in solution at 735 nm, which is easily monitored via absorption spectroscopy.

There are also provided methods comprising partially coating a nanotube with colloidal silica, imbibing said silica with a bio-reactive molecule, contacting the coated nanotube with a vesicle, and delivering said molecule to said vesicle. The delivery method may also comprise partially coating a nanotube with colloidal silica, imbibing said silica with a bio-reactive molecule, passing through a vesicle with said coated nanotube, and delivering said molecule. As discussed previously, there are methods of partially coating a nanotube with a biofunctional coating; passing the coated nanotube through a vesicle or lipid membrane, such as a cell or cell membrane; and extracting a molecule from the interior of the vesicle or lipid membrane.

There are also probing systems comprising a nanotube at least partially coated with a biocompatible coating as described above, a microscope, and micron-resolved mechanical control. One skilled in the art may use some embodiments by utilizing atomic force microscope (AFM) technology for force sensing and fine position of the nanoprobe, as well as the longitudinal penetration translations. Light microscopes and micron-resolved mechanical control may be also be used so may other control and sensing modalities.

There are also probing methods comprising partially coating a nanotube with a biocompatible coating as described above to form a bio-functional nanoprobe and contacting a lipid membrane with said nanoprobe. Other methods comprise partially coating a nanotube with a biocompatible coating comprising silica to form a bio-functional nanoprobe; absorbing said coating with a bio-reactive molecule; contacting a lipid membrane with said nanoprobe; and expelling said molecule from said coating.

The embodiments of the present invention may be used to transport a substance from the interior of a tubular fiber or nanotube into a vesicle or lipid membrane, cell or cell nucleus. The embodiments of this invention are non-deleterious or non-destructive to the vesicle. The development of fluidics at the sub-micron scale may be required in facilitating this transport.

Some embodiments may use the nanoprobes to deliver a substance that is a component of the coating on the exterior side-walls and/or the tip of the probe. Two technologies may be used for the production of bio-functional materials in which active enzymes are sterically-confined, yet active; one is a polymer-based composite, the other a sol-gel ceramic composite. The remaining technology development may be the conversion of these bulk materials into coatings on the fibers, which could involve chemical reaction development.

This invention also provides embodiments where the substance to be delivered is covalently bonded to the exterior of the fiber through a chemically functional ligand. This may involve the direct functionalization of the fiber surface with bio-active molecules via chemical ligands. Other potentially useful configurations of the system provide provisions for creating an electrostatic potential between the probe and the cell interior and/or the encapsulation of optically-emitting molecules (especially in the near-IR) within the lumen of tubular fibers as a means for probe location and optical stimulation of the cell.

### EXAMPLES

MWNTs are refluxed for three hours in concentrated nitric acid at 85° C.-100° C. under constant stirring. This mixture is then centrifuged and washed until the pH of the resulting suspension measure approximately 6.0. At this point the suspension is sonicated in a bath sonicator for approximately 15 minutes to reduce aggregation.

The MWNTs are coated with polyethyleneimine (PEI). A solution of 5 mM PEI in de-ionized water is made. To this the acid-treated MWNTs are added. This suspension is sonicated for 24 hours in a bath sonicator. The suspension is then centrifuged and washed twice to remove excess PEI. The MWNTs are suspended in phosphate buffer solution (PBS) at a pH of 7.2.

To this suspension of PEI-coated MWNTs is added HRP at a concentration of 1 mg/mL. Ludox® Colloidal Silica (provided by Grace Davison) SM-30 colloidal silica is also added at a silica weight concentration of less than 1%. This mixture is placed in a refrigerator at 4° C. under constant stirring for 5 days. At the end of 5 days, the mixture is centrifuged and washed twice at 4° C. with PBS. This step is intended to remove as much excess colloidal silica as possible.

The suspension is then filtered with copious amounts of PBS. After each filtration step, the filtrate is evaluated on the absorption spectrometer for HRP reactivity. The standard method that has been developed is as follows. In a 10 mm quartz cuvette, 3 mL of 0.1 M ABTS in PBS is mixed with 5 μL of 0.1% H₂O₂. The instrument is set-up to monitor the absorption of the solution at 735 nm. The ABTS/ H₂O₂ solution is used to zero the instrument at 735 nm. Then 1 mL of filtrate is added to the cuvette and the reaction is monitored. When the reactivity of the filtrate is deemed negligible, the suspension containing the bio-fimctional MWNTs can be tested with the confidence that free HRP in the PBS is not contributing significantly to the reaction. The absorption spectroscopy of the bio-functional MWNTs is carried out similar to the evaluation described above.

TEM images are also obtained of the bio-functional MWNTs. The TEM samples are prepared on holey carbon, copper grids. The suspension containing the MWNTs is diluted at a ratio of 1:10 and sonicated for approximately 5 seconds. Then 10 μL of this dilute suspension is applied to the TEM grid. The drop of suspension is allowed to sit for approximately 15 minutes before being wicked away with a small piece of glass fiber filter paper. The TEM grid is then stored in a vacuum desiccator until TEM inspection. All TEM inspections are carried out at either 80 kV or 100 kV.

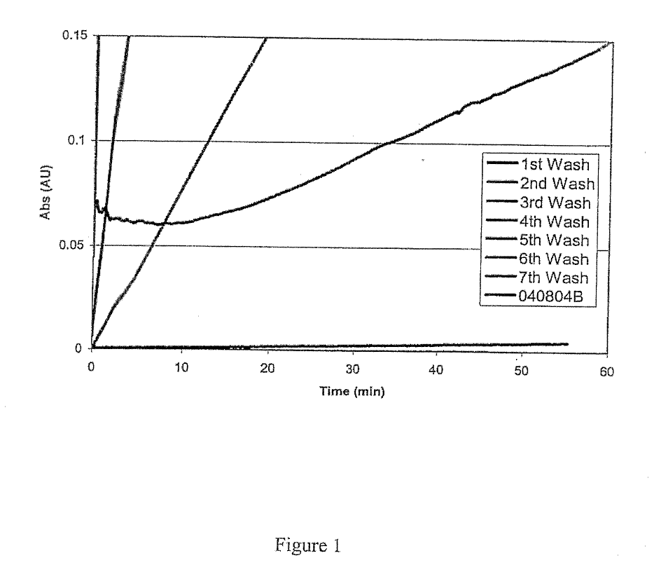

Absorption Spectroscopy Results: Two batches of bio-functional MWNTs were produced by the method above. The results for one batch are shown in FIG. 1. The seven washes are shown in the figure to illustrate the washing process. Each wash showed successively less activity than the previous wash. The blue curve represents the activity of the bio-functional MWNTs of one batch in a suspension of PBS. One can see that the activity is clearly greater than that of either the 6th or 7th washes. This is indicates that the greatest source for HRP activity are the bio- fimctional MWNTs.

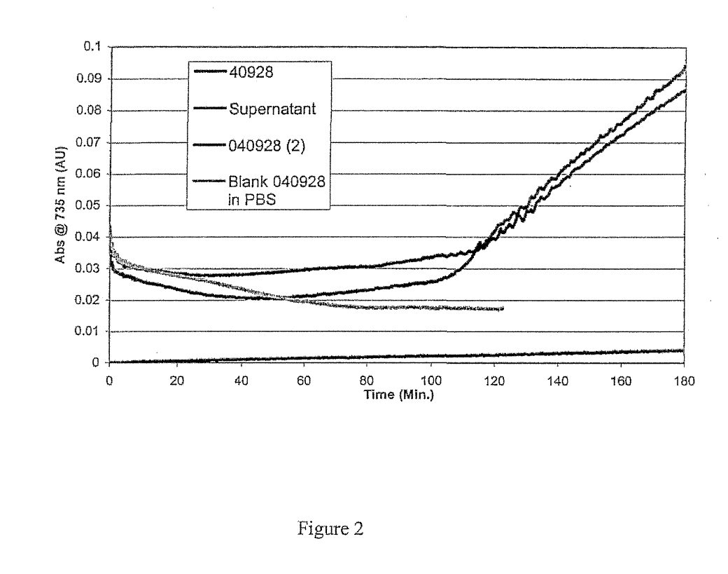

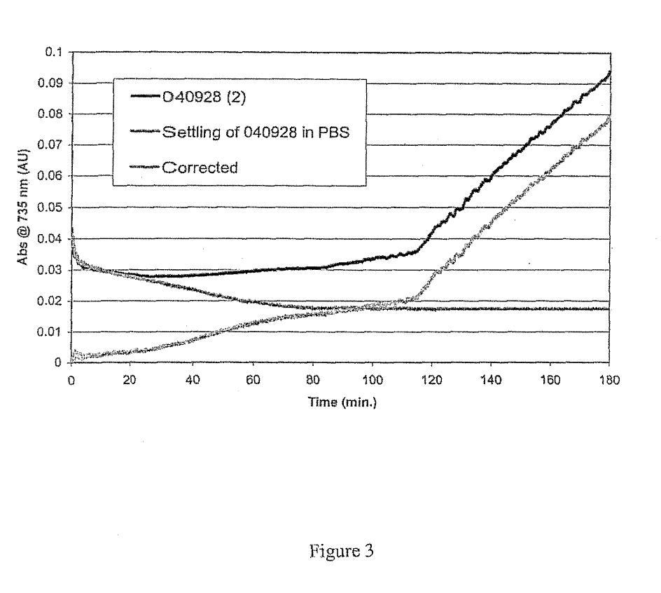

Similar results were obtained with another batch. The absorption spectroscopy results for this batch are shown in FIG. 2. The pink curve represents the reactivity of the supernatant obtained after the final wash. The red and blue curves represent two different data sets from this batch, while the light blue curve shows the settling of the bio-fimctional MWNTs in PBS without ABTS or H₂O₂ present. The settling of the MWNTs was then subtracted from the red curve as shown in FIG. 3. The reaction for this batch was monitored for 180 minutes, and it showed two regions of activity. The first region has a shallow slope that occurs from the start of the reaction, and the second region shows a much steeper slope that occurs after approximately 110 minutes. The reason for the two different stages of reactivity is unexplained as of yet.

Both of these batches showed significantly greater activity than the final wash filtrate. This indicates that the HRP is immobilized on the MWNTs by the coating of Ludox® silica particles. However, there is present a significant amount of silica agglomerates that may be lending to the overall activity of the batch. Currently there is no method for removing the entirety the excess silica agglomerates.

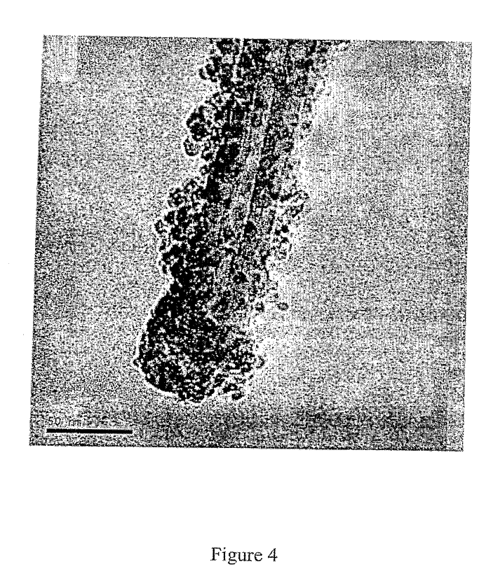

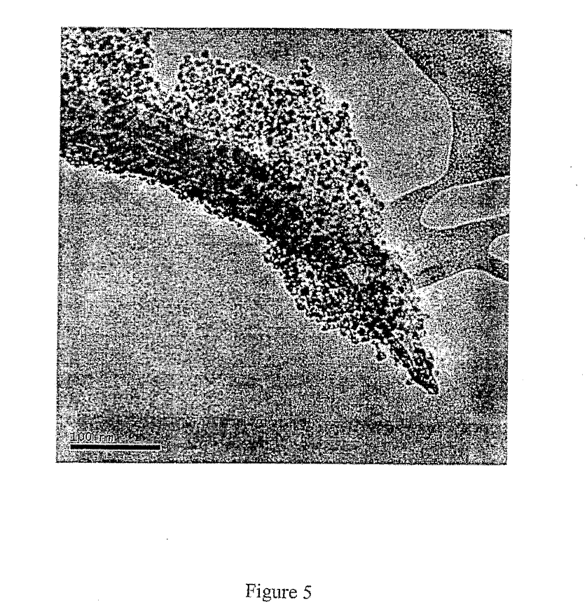

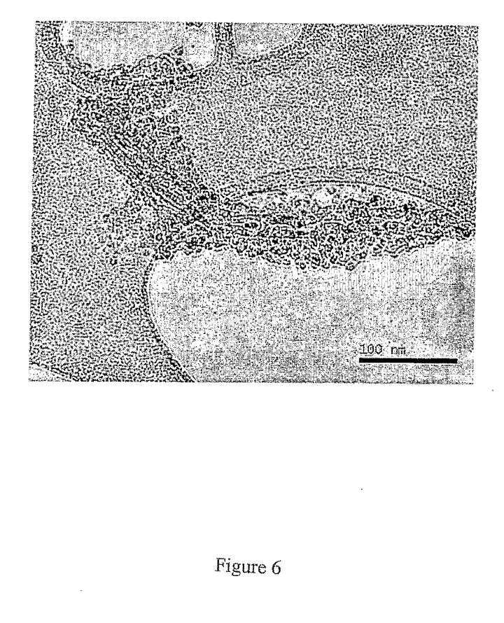

TEM Results: TEM evaluation was performed on both of the batches mentioned above. Both batches exhibited MWNTs coated with Ludox® particles. Most of the MWNTs were isolated, however some tangles of MWNTs were observed. A majority of the bio-functional MWNTs were less than 1 μm in length. This fact is probably due to the long period of sonication that is required during the PEI coating step. The HRP that is entrapped in the Ludox® coating is not visible within the TEM. This is probably due to the fact that the enzyme does not have sufficient density to cause contrast between the MWNTs and silica particles. FIGS. 4 and 5 show typical Ludox®-coated MWNTs from the first batch. FIG. 6 shows a typical MWNT from the second batch.

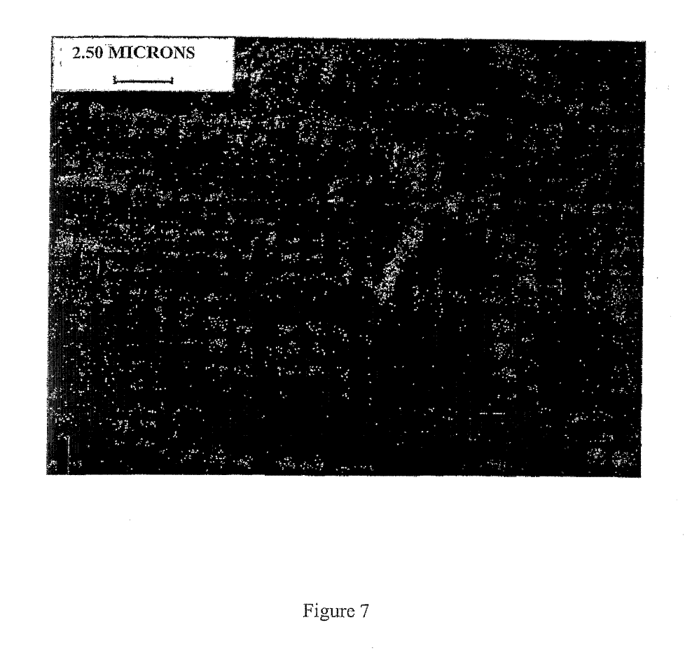

Fluorescence microscopy was used to confirm that the enzyme is bound to the nanoprobe as shown in FIG. 7. HRP was functionalized with a fluorescent tag prior to creation of the nanoprobe. After nanoprobe synthesis, the nanoprobe was repeatedly washed to remove all unbound HRP. The nanoprobe was then imaged in a fluorescence microscope; the fluorescent image is shown in the figure. The strong localization of the fluorescence signal to the high-aspect ratio object in the image is consistent with the functional HRP being bound within the colloidal silica coating on the nanotube.

What is claimed is:

1. A probing tool comprising a nanotube at least partially coated with a biocompatible coating comprising silica capable of absorbing bioreactive molecules.

2. The probing tool of claim 1 wherein said coating comprises a medicament.

3. The probing tool of claim 1 wherein said coating is porous.

4. The probing tool of claim 1 wherein said silica is spherical colloidal silica particles.

5. The probing tool of claim 1 wherein said coating absorbs bio-reactive molecules.

6. The probing tool of claim 1 wherein said coating comprises a marking enzyme.

7. The probing tool of claim 1 wherein said coating comprises horseradish peroxidase.

8. The probing tool of claim 1 wherein said nanotube is a multi-walled nanotube.

9. The probing tool of claim 1 wherein said nanotube is a double-walled nanotube.

10. The probing tool of claim 1 wherein said nanotube comprises C₆₀ molecules within its lumen.

11. A probing system comprising a nanotube at least partially coated with a biocompatible coating capable of absorbing bioreactive molecules, a microscope, and micron-resolved mechanical control.

12. The system of claim 11 wherein said microscope is a light microscope or an atomic force microscope.

13. The system of claim 11 wherein said nanotube is a multi-walled nanotube.

14. The system of claim 11 wherein said nanotube is a double-walled nanotube.

15. The system of claim 11 wherein said nanotube comprises C₆₀ molecules within its lumen.

16. The system of claim 11 wherein said coating comprises a medicament.

17. The system of claim 11 wherein said coating is porous.

18. The system of claim 11 wherein said coating comprises silica.

19. The system of claim 11 wherein said silica is spherical colloidal silica particles.

20. The system of claim 11 wherein said coating absorbs bio-reactive molecules.

21. The system of claim 11 wherein said coating comprises an enzyme.

22. The system of claim 11 wherein said coating comprises horseradish peroxidase.

23. A probing method comprising:
partially coating a nanotube with a biocompatible coating comprising silica to form a bio-fimctional nanoprobe and
contacting a vesicle with said nanoprobe.

24. The method of claim 23 wherein said nanotube is a multi-walled nanotube.

25. The method of claim 23 wherein said nanotube is a double-walled nanotube.

26. The method of claim 23 wherein said nanotube comprises C₆₀ molecules within its sidewalls.

27. The method of claim 23 wherein said coating is porous.

28. The method of claim 23 wherein said coating comprises colloidal silica.

29. The method of claim 23 wherein said coating comprises spherical silica particles.

30. The method of claim 23 wherein said coating further comprises a medicament.

31. The method of claim 23 wherein said coating further comprises a marking enzyme.

32. The method of claim 23 wherein said coating further comprises horseradish peroxidase.

33. The method of claim 23 wherein said vesicle is a lipid membrane

34. The method of claim 23 wherein said lipid membrane is a cell or cell nucleus.

35. The method of claim 23 wherein said contacting step is non-destructive to the lipid membrane.

36. The method of claim 23 further comprising penetrating the lipid membrane.

37. The method of claim 23 further comprising attracting a molecule to said coating.

38. A probing method comprising:
partially coating a nanotube with a biocompatible coating comprising silica to form a bio-functional nanoprobe;
absorbing said coating with a bio-reactive molecule;
contacting a vesicle with said nanoprobe; and
expelling said molecule from said coating.

39. The method of claim 38 wherein said nanotube is a multi-walled nanotube.

40. The method of claim 38 wherein said nanotube is a double-walled nanotube.

41. The method of claim 38 wherein said nanotube comprises C₆₀ molecules within its sidewalls.

42. The method of claim 38 wherein said coating is porous.

43. The method of claim 38 wherein said coating comprises colloidal silica.

44. The method of claim 38 wherein said coating comprises spherical silica particles.

45. The method of claim 38 wherein said coating comprises a medicament.

46. The method of claim 38 wherein said molecule is a medicament.

47. The method of claim 38 wherein said coating comprises a marking enzyme.

48. The method of claim 38 wherein said coating comprises horseradish peroxidase.

49. The method of claim 38 wherein said contacting step is non-destructive to the vesicle.

50. The method of claim 38 wherein said vesicle a lipid membrane

51. The method of claim 38 wherein said lipid membrane is a cell or cell nucleus.

52. The method of claim 38 wherein said contacting step is non-destructive to the lipid membrane.

53. The method of claim 38 further comprising penetrating the lipid membrane.

54. The method of claim 38 wherein said expulsion step is driven by nanofluidics or molecular transport.
